(19) United States
(12) Patent Application Publication
(10) Pub. No.: US 2021/0113874 A1
(43) Pub. Date: Apr. 22, 2021

(54) Firefighter Training Devices

(71) Applicant: Chris King, Chicago, IL (US)

(72) Inventor: Chris King, Chicago, IL (US)

(21) Appl. No.: 17/072,599

(22) Filed: Oct. 16, 2020

Related U.S. Application Data
(60) Provisional application No. 62/923,118, filed on Oct. 18, 2019.

(51) Int. Cl. A62C 99/00; G09B 23/00

(52) U.S. Cl. CPC A62C 99/0081; G09B 23/00

(57) ABSTRACT

Firefighter training devices for wall breaches, cutting chains and/or bars and/or performing roof ventilations are disclosed. In some embodiments, the device is a modular firefighter training fixture. In some embodiments, the modular firefighter training fixture includes a cut-training module, a roof module, and/or a horizontal wall module. In some embodiments, the device is a firefighter training tree. In some embodiments the device is a modular partition system.

### CROSS-REFERENCE TO RELATED APPLICATION

This application is related to and claims priority benefits from U.S. provisional patent application Ser. No. 62/923,118 filed on Oct. 18, 2019, entitled “Firefighter Training Devices”. The '118 application is hereby incorporated by reference herein in its entirety.

### FIELD OF THE INVENTION

The present invention relates to firefighting training equipment. In particular, the invention relates to devices for teaching various firefighter skills including performing wall breaches, cutting chains, cables, padlocks, and/or bars and/or performing roof ventilations. The invention is also related to devices used for simulating various situations firefighters often find in the field.

While fighting fires, firefighters often must perform wall breaches, cut chains, cables, padlocks, bars, and perform roof ventilations. These techniques are important, potentially lifesaving skills that a well-trained firefighter should know how to accomplish.

Traditionally, firefighters train for these techniques by attending lectures, reading training guides and improving their overall strength and endurance via traditional exercises in a gym.

While useful for improving a firefighter's strength and endurance and providing some background context, these traditional training methods are not ideal. These training methods do not simulate a real-life firefighting experience.

A second method used to tune these techniques is to practice on dilapidated buildings that are scheduled to be torn down. Again, this method is not ideal, as it requires a fire department to continually seek out new training locations.

Recently the use of firefighter training fixtures, such as those disclosed in U.S. Pat. No. 10,083,623 have been recognized as additional training methods. These fixtures allow for firefighters and trainees to practice various techniques in affordable and easily repeatable scenarios. The '623 patent is incorporated by reference in its entirety.

What is needed are easily movable devices that enable firefighters and trainees to practice the real-world movements, skills and techniques involved in performing wall breaches, cutting chains, cables, padlocks, and/or bars and/or performing roof ventilations in a safe, convenient, affordable and easily repeatable scenario.

### SUMMARY OF THE INVENTION

A training fixture can include a ceiling section mounted on at least one side section. If only one side section is used, the fixture can be leaned against or attached to a wall. In other embodiments, the fixture is configured to be stable with only one side section.

In some embodiments, the side section(s) can include adjustable arms that allow the height of the ceiling section to vary. In at least some embodiments, the ceiling section includes one or more compartments with ceiling panels, such as drywall panels, so that firefighter trainees can learn and practice the ceiling pull and breach maneuvers. In some embodiments, the compartments can also include piping and/or wiring to simulate the electrical conduit, wiring, and fluid (water and gas) utility pipes often found in ceilings. In some embodiments, at least one of the pipes can be connected to a water source and configured to spray water on the firefighter trainees. These features provide for more realistic training, as firefighters need to be able to perform the ceiling pull while avoiding obstacles in ceilings and/or being sprayed with water from a busted pipe and/or an overhead sprinkler system.

In some embodiments, an optional step ladder is attached to the training fixture to allow individuals to readily install ceiling panels into the compartments.

The training fixture can be formed from a variety of materials, including but not limited to wood, steel, plastic and aluminum. In some instances, aluminum is a preferred material as it is light and fire resistant, thereby allowing the fixture to be placed near open flames often used during training.

In some embodiments, the training fixture is a modular firefighter training fixture which includes a cut-training module; a horizontal wall module and/or a roof module.

In some embodiments, the cut-training module includes a support structure; at least one pipe; at least one hook; and at least one chain.

In some embodiments, the horizontal wall module includes a horizontal support; a pair of vertical supports; a wall piece; and a device to hold the wall piece between the pair of vertical supports.

In some embodiments, the horizontal support includes at least one notch to accept a vertical stud. In some embodiments, the vertical stud is made of wood.

In some embodiments, a firefighter training tree includes a base; at least one pipe; at least one hook; at least one chain; a vertical support structure; and/or a horizontal support structure.

In some embodiments, the training equipment includes a modular partition system.

In some embodiments, the modular firefighter training fixture includes a pair of oppositely disposed upwardly extending side sections; a ceiling section interposed between an upper portion of each of said side sections, said ceiling section comprising at least one compartment for receiving at least one panel; and a horizontal wall module.

In some embodiments, the modular firefighter training fixture includes a cut-training module.

In some embodiments, the cut-training module includes a support structure; at least one pipe; at least one hook; and/or at least one chain.

In some embodiments, the horizontal wall module includes a horizontal support; a pair of vertical supports; a wall piece; and/or a device to hold the wall piece between the pair of vertical supports.

In some embodiments, the horizontal wall module includes a horizontal stud holder with at least one notch to accept a vertical stud

In some embodiments, the vertical stud is made of wood.

In some embodiments, the modular firefighter training fixture includes a side storage compartment configured to store at least one panel.

In some embodiments, the modular firefighter training fixture includes a door compartment configured to hold a door.

In some embodiments, the modular firefighter training fixture includes at least one pair of wheels.

In some embodiments, the ceiling section has a locking mechanism configured to keep the panel in the compartment.

In some embodiments, the ceiling section comprises at least one pipe.

In some embodiments, the device of the horizontal wall module is a magnetic-based device.

In some embodiments, the wall piece is one of a drywall panel, a plywood board, a medium-density fiberboard panel, a particle board, a solid wood board, a reinforced polyurethane foam board, a oriented strand board, or a high-density fiberboard panel.

In some embodiments, the horizontal wall module includes at least one pipe and a length of wire. In some embodiments, at least one of the pipes can be connected to a water source and configured to spray water on the firefighter trainees.

In some embodiments, the modular firefighter training fixture includes a firefighter training tree, wherein the tree includes a base; at least one steel bar; at least one hook; at least one chain; a vertical support structure; and/or a horizontal support structure.

In some embodiments, the modular firefighter training fixture includes a roof module. In some embodiments, the roof module includes: a roof module support structure, a ladder; a roof covering; an attic floor structure; and/or an adjustable vertical support configured to adjust a pitch of the roof covering.

In some embodiments, the roof module support structure comprises at least one notch to receive at least one rafter support.

In some embodiments, the attic floor structure includes at least one pipe and a length of wire. In some embodiments, at least one of the pipes can be connected to a water source and configured to spray water on the firefighter trainees.

### BRIEF DESCRIPTION OF THE DRAWINGS

FIG. 1 is a perspective view of a firefighter trainer installing a drywall panel into a modular firefighter training fixture.

FIG. 2 is an exploded perspective view of a modular firefighter training fixture.

FIG. 3 is a perspective view of a compartment in a modular firefighter training fixture for mounting a drywall panel or ceiling tile.

FIG. 4 is a front sectional view of a portion of a modular firefighter training fixture.

FIG. 5 is an exploded view of a modular firefighter training fixture with a horizontal wall module and two cut-training modules.

FIG. 6 is a front view of a cut-training module.

FIG. 7 is a top view of a cut-training module.

FIG. 8 is a side sectional view of a cut-training module taken along line A of FIG. 6.

FIG. 9 is a side sectional view of a horizontal wall module taken along line B of FIG. 5.

FIG. 10 is a front view of a horizontal wall module.

FIG. 11 is a top sectional view of a horizontal wall module taken along line C of FIG. 10.

FIG. 12 is a front perspective view of a horizontal wall module with a wall panel attached.

FIG. 13 is a front perspective view of a modular partition system.

FIG. 14 is a top view of an end partition support used in the modular partition taken along line D.

FIG. 15 is a top view of a middle partition support used in the modular partition builder taken along line E.

FIG. 16 is a top view of multiple partition supports and wall pieces being used to create a modular partition system.

FIG. 17 is a perspective view of a firefighter in a modular partition system.

FIG. 18 is a front perspective view of a modular partition system with a ceiling.

FIG. 19 is a firefighter training tree.

FIG. 20 is an exploded view of the firefighter training tree of FIG. 19.

FIG. 21 is a perspective view of a roof module for a modular firefighter training device in a sloped roof configuration.

FIG. 22 is a closeup cutaway view of section F of FIG. 21.

FIG. 23 is a perspective view of a roof module for a modular firefighter training device in a sloped roof configuration with an attic floor section.

### DETAILED DESCRIPTION OF PREFERRED EMBODIMENT(S)

### Modular Firefighter Training Fixture

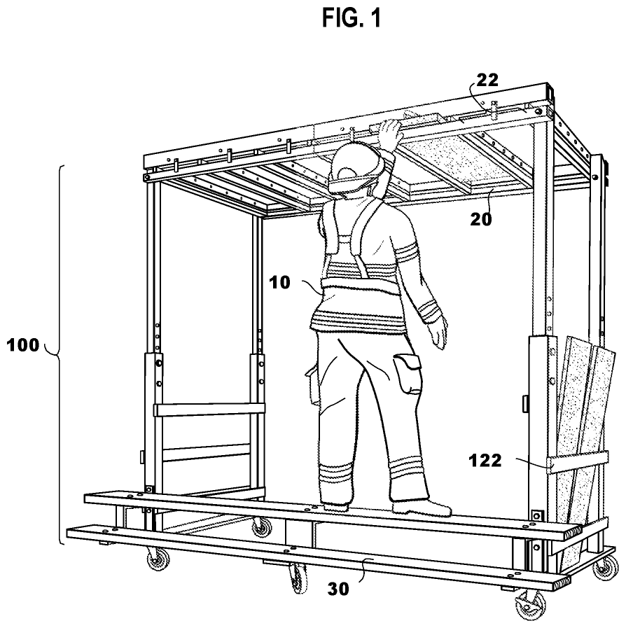

FIG. 1 shows firefighter trainer 10 placing drywall panel 20 into compartment 22 of modular firefighter training fixture 100. A variety of materials can be used in place a drywall panels, including but not limited to, oriented strand boards, cement boards, plywood, ceiling tiles, and plaster boards.

In some embodiments, support braces can be added to compartment 22 to increase its structural integrity. In some embodiments these braces are metal.

In some embodiments, modular firefighter training fixture 100 includes side storage compartment 122. Side storage compartment 122 can be used, for example, to store extra drywall panels 20 when in use during training. Side storage compartment 122 can also be used to hold pike hooks when not in use.

In some embodiments, modular firefighter training fixture 100 has step ladder 30 to aid in installing and removing drywall panel 20 into compartment 22. This is especially advantageous when modular firefighter training fixture 100 has been raised to simulate a high ceiling.

In some embodiments modular firefighter training fixture 100 can be placed on its side to simulate a wall instead of a ceiling. In other embodiments, modular firefighter training fixture 100 has a wall simulator compartment that can be configured to hold drywall panels. These embodiments allow firefighter trainees to practice wall breaches.

In certain embodiments, modular firefighter training fixture 100 can include a door compartment. The door compartment can be configured to hold a door that can be used to practice forcible-entries.

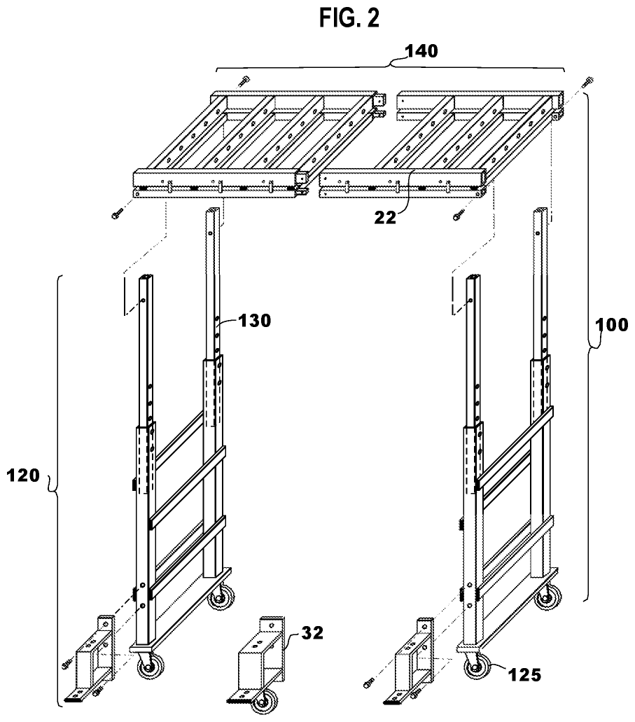

FIG. 2 shows an exploded view of modular firefighter training fixture 100. Modular firefighter training fixture 100 can consist of two side sections 120. These side sections 120 can be made up of adjustable arms 130 to allow for ceiling section 140 to be placed at different heights.

In some embodiments, side sections 120 can include wheels 125 to make modular training fixture 100 easier to move. In certain embodiments, wheels 125 can lock into place so that modular training fixture 100 does not move around when in use. In some embodiments, step ladder 30 (see FIG. 1) can also be attached to side sections 120 using, among other methods, brackets 32.

Ceiling section 140 can include a plurality of compartments 22 for the insertion of various ceiling materials. In some embodiments, ceiling section 140 contains six compartments 22 that can be filled with 16 inch by 48 inch drywall panels which replicates the 16 inch center construction for joints and rafters.

In some embodiments, ceiling section 140 is configured to be readily disassembled into two or more pieces for easier storage and/or transportation.

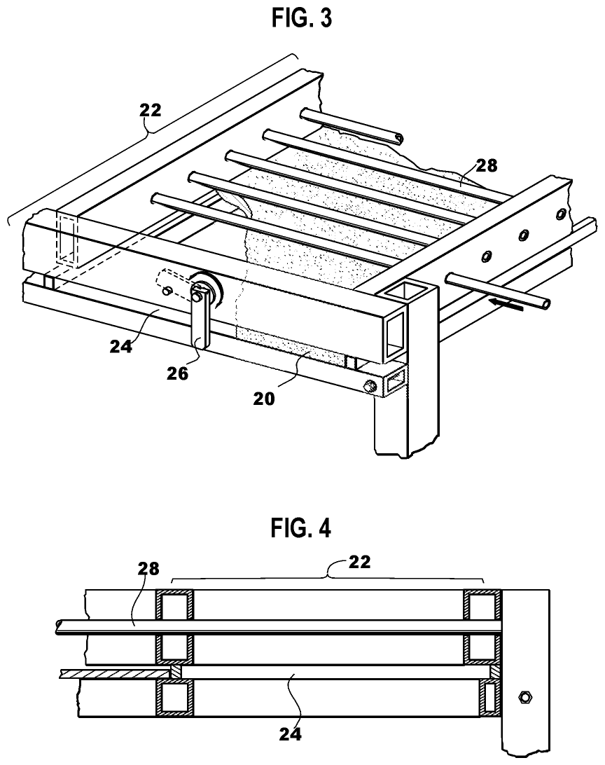

FIG. 3 shows a closeup view of compartment 22 of ceiling section 140. Drywall panel 20 has been placed into slot 24. In some embodiments locking mechanism 26 is used to keep drywall panel 20 in slot 24.

In some embodiments, piping 28 can be placed across compartment 22 to simulate electrical conduit that is often encountered by firefighters in the field.

FIG. 4 is a close-up cutaway view of compartment 22. Slot 24 is readily distinguishable, as is piping 28. In some embodiments, slot 24 is configured to receive one-half inch (1.3 cm) drywall panels, although other thickness can also be used.

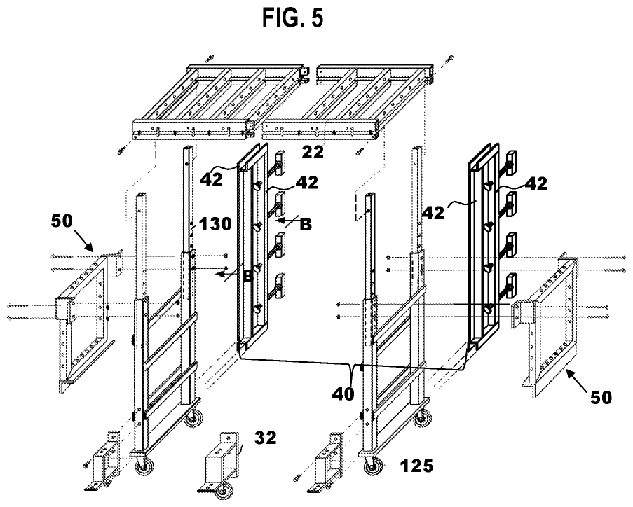

FIG. 5 is an exploded view of modular firefighter training fixture 100 utilizing both horizontal wall module 40 and two cut-training modules 50.

In at least some embodiments, horizontal wall module 40 includes four vertical supports 42 that can attach to modular firefighter training fixture 100. In some embodiments, horizontal wall module 40 connects to modular firefighter training fixture 100 via horizontal support 41. In some embodiments, wall piece 43 is held between pairs of vertical supports 42 using support screw 44. In some embodiments, wall piece 43 is held between pairs of vertical supports 42 using a tension-based device such as a spring. In some embodiments, wall piece 43 is held between pairs of vertical supports 42 using a magnetic-based device.

In some embodiments, wall piece 43 can be made of, among other things, drywall, plywood, medium-density fiberboard (MDF), particle board, solid wood, reinforced polyurethane foam boards, oriented strand board (OSB), EKOply, and/or high-density fiberboard. In some embodiments, horizontal wall module 40 can have one or more compartments that can include piping and/or wiring to simulate the electrical conduit, wiring, and fluid (water and gas) utility pipes often found in walls.

In some embodiments, horizontal wall module 40 includes a pair of horizontal stud holders parallel to wall piece 43 with vertical studs running between the horizontal stud holders to simulate wall studs. In some embodiments, the vertical studs are made of wood and can be readily replaced. In some embodiments, the vertical studs are evenly spaced roughly every 16 inches. In some embodiments, at least the bottom horizontal stud holder includes notches to readily accept the vertical studs.

In some embodiments, modular firefighter training fixture 100 includes a garage door module that allows a firefighter to practice cutting, among other things, corrugated steel.

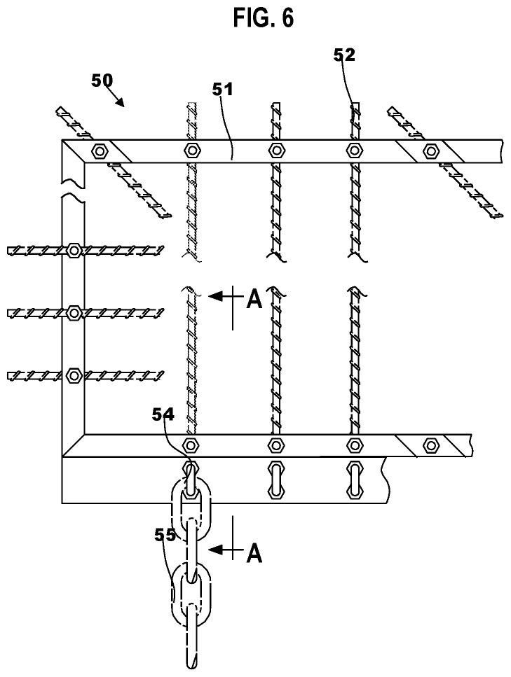

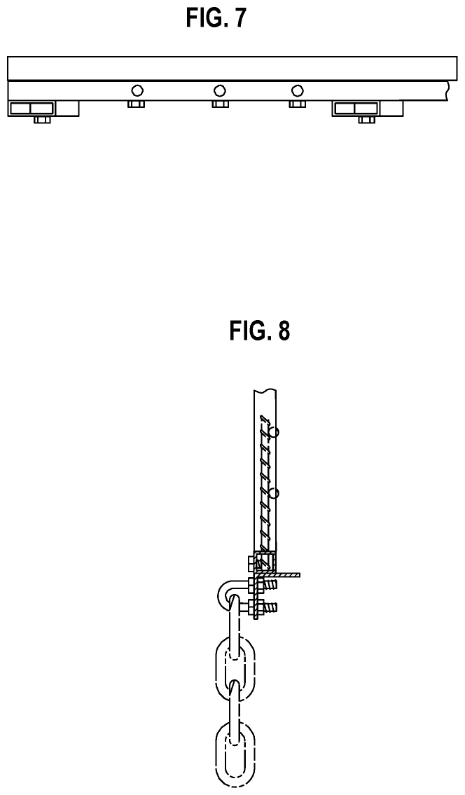

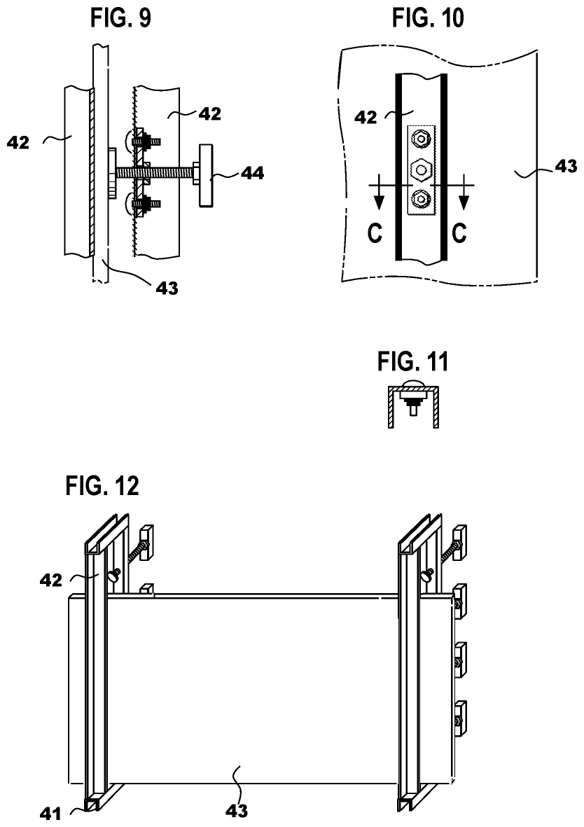

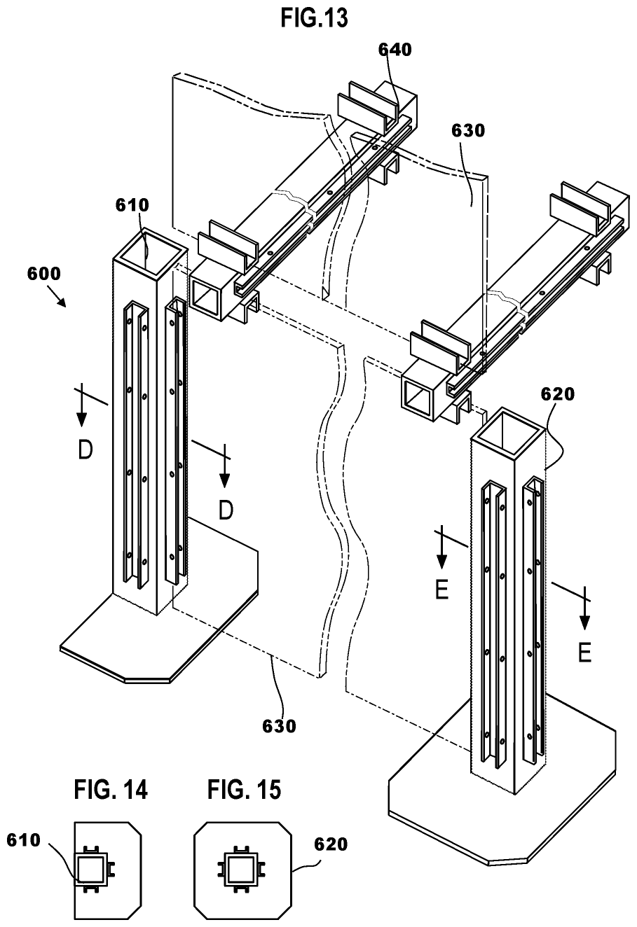

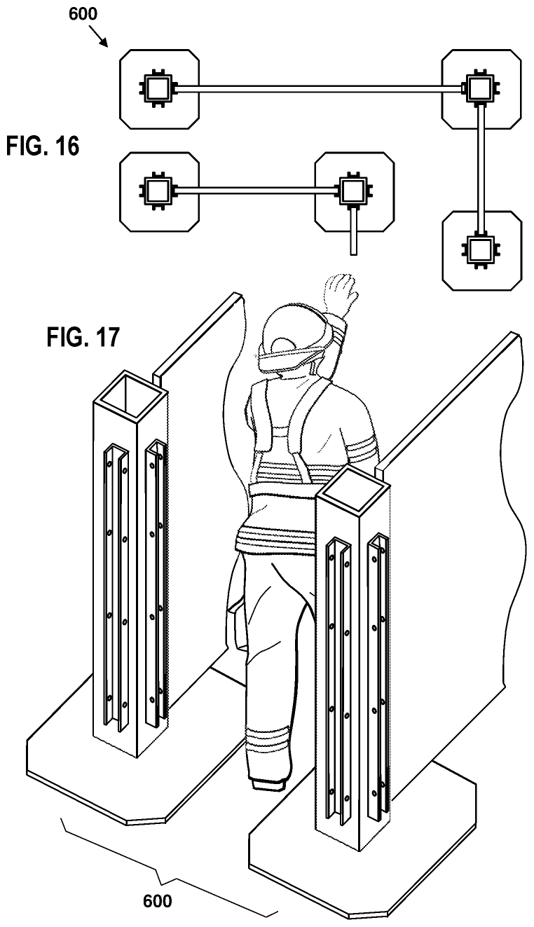

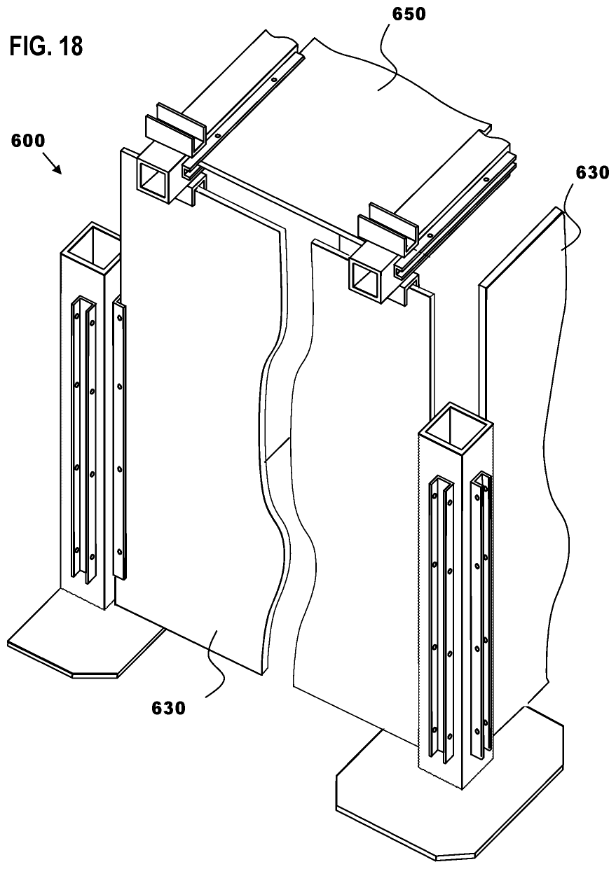

FIG. 6 illustrates a front view of cut-training module 50. In some embodiments, cut-training module 50 can be used by a firefighter to practice cuts commonly performed in the field such as, but not limited to, cutting steel bars, cables, padlocks, and/or chains. In some embodiments, cut-training module 50 can include a support structure 51. In some embodiments, support structure 51 is configured to receive pipes 52. In some embodiments, pipes 52 are hollow. In some embodiments, pipes 52 are solid steel bars. In some embodiments, support structure is configured to hold pipes 52 in a horizontal, vertical, and/or diagonal configuration. In some embodiments, support structure 51 includes bolts, nuts, screws, pins, and/or other means of holding pipes 52. In some embodiments, pipes 52 can be, among other things, steel bars, rebar, and/or dowels.

In some embodiments, support structure 51 includes at least one hook 54. In some embodiments, hook 54 is configured to open to accept chain 55. In some embodiments, a clip is used in place of or in addition to hook 54.

### Modular Partition System

Firefighters, emergency personnel, and other first responders need to be able to quickly navigate unfamiliar interior structures. Modular partition system 600 allows for various layouts to be created relatively quickly. In some embodiments, vertical partition supports such as end partition support 610 and middle partition support 620, along with other partition supports can be used to create various layouts, such as the one shown in FIG. 16.

In at least some embodiments, at least one wall section 630 is placed between two partition supports, such as end partition support 610 and middle partition support 620. Wall section 630 can be made of, among other things, drywall, plywood, medium-density fiberboard (MDF), particle board, solid wood, reinforced polyurethane foam boards, oriented strand board (OSB), EKOply, and/or high-density fiberboard.

In some embodiments, end partition support 610 is flat on at least one side to allow modular partition system 600 to utilize permanent walls, such as a wall of a building for at least one part of the modular partition system 600.

In some embodiments, modular partition system 600 can include ceiling supports 640. In some embodiments, such as the one shown in FIG. 13, ceiling supports 640 allow for the placement of additional wall sections 630 to increase the height of modular partition system 600. In some embodiments, such as the one shown in FIG. 13, ceiling supports 640 allow for the placement of ceiling section 650. In some embodiments, ceiling section 650 can support the weight of an individual, such that when properly configured, ceiling supports 640, ceiling section 650 and partition supports can be used to create a multi-story modular partition system 600.

In some embodiments, ceiling supports 640, end partition support 610 and/or middle partition support 620 can be configured to have one or more compartments between them that can include piping and/or wiring to simulate the electrical conduit, wiring, and fluid (water and gas) utility pipes often found in walls.

Modular partition system 600 can be formed from a variety of materials, including but not limited to wood, steel, plastic and aluminum. In some instances, aluminum is a preferred material for ceiling supports 640, end partition supports 610 and/or middle partition supports 620 as it is light and fire-resistant, thereby allowing the fixture to be placed near open flames often used during training.

### Training Tree

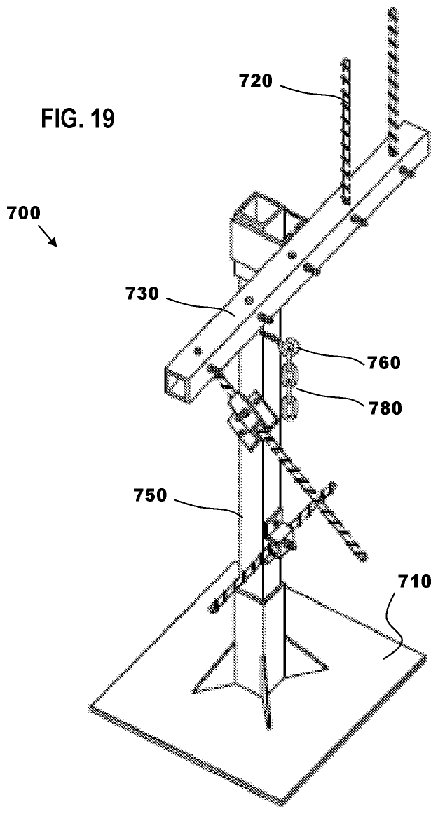

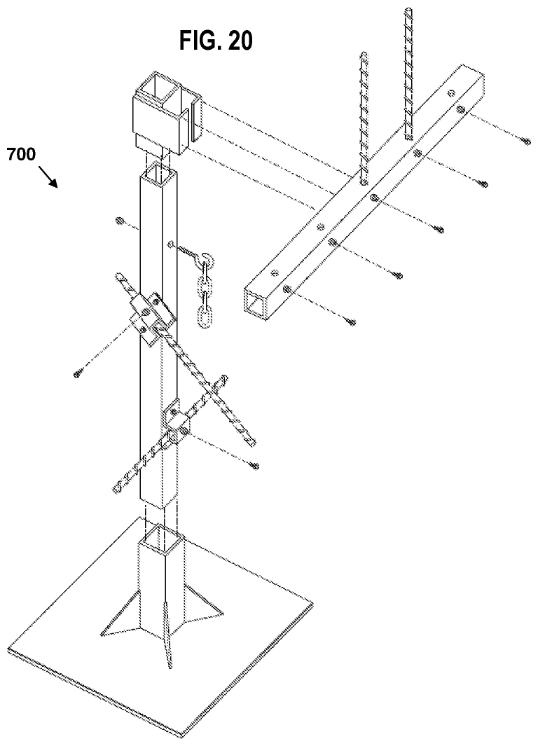

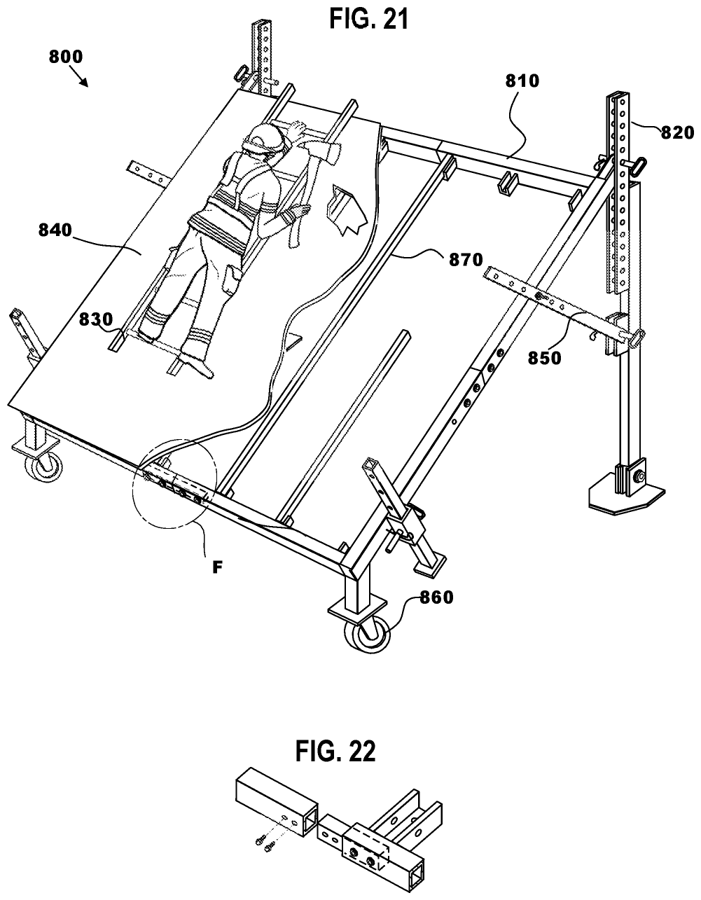

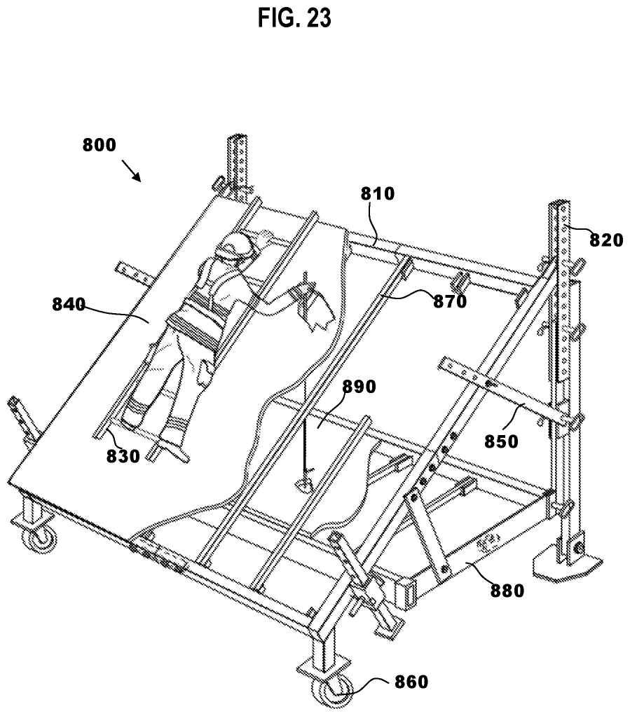

Firefighter training tree 700 is shown in FIG. 19. In some embodiments, firefighter training tree 700 can be used by a firefighter to practice cuts commonly performed in the field, such as cutting steel bars, pipes, and/or chains. In some embodiments, firefighter training tree 700 can include a vertical support structure 750, a horizontal support structure 730, and base 710. In some embodiments, vertical support structure 750 and/or horizontal support structure 730 are configured to receive pipes 720. In some embodiments, vertical support structure 750 and/or horizontal support structure 730 are configured to hold pipes 720 in a horizontal, vertical, and/or diagonal configuration. In some embodiments, firefighter training tree 700 includes bolts, nuts, screws, pins, and/or other means of holding pipes 720.

In some embodiments, pipes 720 can be, among other things, steel bars, rebar, and/or dowels.

In some embodiments, firefighter training tree 700 includes at least one hook 760. In some embodiments, hook 760 is configured to open to accept chain 780. In some embodiments, a clip is used in place of or in addition to hook 760.

In some embodiments, firefighter training tree 700 can be part of a modular firefighter training fixture, such as the ones shown in FIG. 1 and FIG. 5. In some embodiments, firefighter training tree 700 can be part of a roof module, such as the one shown in FIG. 21.

### Roof Module

Roof module 800 is shown in FIG. 21. Roof module 800 can include a roof module support structure 810, adjustable vertical supports 820, ladder 830, roof covering 840, support brace 850, wheels 860, rafter support 870, attic floor structure 880, and/or attic floor panel 890.

In some embodiments, roof module 800 attaches to modular firefighter training fixture 100.

In some embodiments, wheels 860 make roof module 800 easier to move. In certain embodiments, wheels 860 can lock into place so that roof module 800 does not move around when in use.

In some embodiments, adjustable vertical supports 820 allow the height and/or pitch of the roof to vary. In some embodiments, vertical supports 820 are configured such that roof covering 840 is held at common pitches such as 4/12, 6/12, 8/12, 10/12, 12/12, 14/12, 16/12, and 18/12. In some embodiments, vertical supports 820 are configured such that roof covering 840 can be held at pitches between 0 degrees and 90 degrees.

In some embodiments, rafter support 870 are made from 2×4s. In some embodiments, roof module support structure 810 is configured to receive rafter supports 870 into notches.

In some embodiments, roof module 800 can be utilized with a garage door to practice garage door cuttings. Firefighters using roof module 800 in this setup can practice proper cut technique, locations and gain actual saw cutting experience.

In some embodiments, when roof module 800 is at a 90-degree position, it can be used to simulate a wall. In some embodiments, a window can be cut out of what is traditionally roof covering 840 so that firefighters can practice wall breeching for self-rescue, firefighter rescue (RIT operations) building construction techniques, and other forcible entry techniques.

In some embodiments, attic floor structure 880 can be configured to have one or more compartments that can include piping and/or wiring to simulate the electrical conduit, wiring, and fluid (water and gas) utility pipes often found in ceilings.

Roof covering 840 can be made of, among other things, drywall, plywood, medium-density fiberboard (MDF), particle board, solid wood, reinforced polyurethane foam boards, oriented strand board (OSB), EKOply, roof shingles, and/or high-density fiberboard.

Attic floor panel 890 can be made of, among other things, drywall, plywood, medium-density fiberboard (MDF), particle board, solid wood, reinforced polyurethane foam boards, oriented strand board (OSB), EKOply, and/or high-density fiberboard. In some embodiments, roof covering 840 is sized to fit a standard 8-foot by 8-foot piece of plywood.

While particular elements, embodiments and applications of the present invention have been shown and described, it will be understood, that the invention is not limited thereto since modifications can be made without departing from the scope of the present disclosure, particularly in light of the foregoing teachings.

What is claimed is:

1. A modular firefighter training fixture comprising:
(a) a pair of oppositely disposed upwardly extending side sections;
(b) a ceiling section interposed between an upper portion of each of said side sections, said ceiling section comprising an at least one compartment for receiving an at least one panel; and
(c) a horizontal wall module.

2. The modular firefighter training fixture of claim 1 further comprising:
(d) a cut-training module.

3. The modular firefighter training fixture of claim 2 wherein said cut-training module comprises:
(i) a support structure;
(ii) an at least one pipe;
(iii) an at least one hook; and
(iv) an at least one chain.

4. The modular firefighter training fixture of claim 1 wherein said horizontal wall module comprises:
(i) a horizontal support;
(ii) a pair of vertical supports;
(iii) a wall piece; and
(iv) a device to hold said wall piece between said pair of vertical supports.

5. The modular firefighter training fixture of claim 4 wherein said horizontal wall module further comprises a horizontal stud holder with an at least one notch to accept a vertical stud.

6. The modular firefighter training fixture of claim 4 wherein said vertical stud is made of wood.

7. The modular firefighter training fixture of claim 1 further comprising:
(d) a side storage compartment configured to store said at least one panel.

8. The modular firefighter training fixture of claim 1 further comprising:
(d) a door compartment configured to hold a door.

9. The modular firefighter training fixture of claim 1 further comprising:
(d) an at least one pair of wheels.

10. The modular firefighter training fixture of claim 1 wherein said ceiling section has a locking mechanism configured to keep said at least one panel in said at least one compartment.

11. The modular firefighter training fixture of claim 1 wherein said ceiling section comprises an at least one pipe.

12. The modular firefighter training fixture of claim 4 wherein said device is a magnetic-based device.

13. The modular firefighter training fixture of claim 4 wherein said wall piece is one of a drywall panel, a plywood board, a medium-density fiberboard panel, a particle board, a solid wood board, a reinforced polyurethane foam board, a oriented strand board, or a high-density fiberboard panel.

14. The modular firefighter training fixture of claim 4 wherein said horizontal wall module further comprises an at least one pipe and a length of wire.

15. The modular firefighter training fixture of claim 1 further comprising:
(d) a firefighter training tree comprising:
(i) a base;
(ii) an at least one steel bar;
(iii) an at least one hook;
(iv) an at least one chain;
(v) a vertical support structure; and
(vi) a horizontal support structure.

16. The modular firefighter training fixture of claim 1 further comprising:
(d) a roof module.

17. The modular firefighter training fixture of claim 16 wherein said roof module includes:
(i) a roof module support structure,
(ii) a ladder;
(iii) a roof covering;
(iv) an attic floor structure;
(v) an adjustable vertical support configured to adjust a pitch of said roof covering.

18. The modular firefighter training fixture of claim 17 wherein said roof module support structure comprises an at least one notch to receive an at least one rafter support.

19. The modular firefighter training fixture of claim 16 wherein said attic floor structure includes at least one pipe and a length of wire.

20. The modular firefighter training fixture of claim 16 wherein said modular firefighter training fixture includes a pair of wheels.
